(19) United States
(12) Patent Application Publication
(10) Pub. No.: US 2015/0243184 A1
(43) Pub. Date: Aug. 27, 2015

(54) COMFORT DEVICE FOR SURGICAL PATIENTS

(71) Applicant: Lani-lee Almich, Coquille, OR (US)

(72) Inventor: Lani-lee Almich, Coquille, OR (US)

(21) Appl. No.: 14/187,629

(22) Filed: Feb. 24, 2014

(51) Int. Cl. G09B 19/00

(52) U.S. Cl. CPC G09B 19/00

(57) ABSTRACT

An anthropological surrogate for comforting a surgical patient, the anthropological surrogate configured to include a retrievable simulated body organ. The body organ is tethered to the interior of a receptacle installed in the body of the anthropological surrogate. The receptacle has an openable closure so that the simulated body organ can be withdrawn from the receptacle and from the anthropological surrogate, viewed, and replaced.

### FIELD OF THE INVENTION

The present invention relates to comfort or consolation for surgical patients, and more particularly, to modifying dolls, stuffed animals, and the like in a way which personalizes the medical experience for the patient.

### BACKGROUND OF THE INVENTION

Medical patients, in particularly the young, are particularly susceptible to demoralization, despair, and other debilitating feelings when subjected to significant medical treatments such as surgery. Dolls and stuffed animals have been provided to such patients as a way of giving them greater understanding of their situation and control over their feelings and other aspects of the medical experience. While dolls and stuffed animals are felt to render some measure of comfort, there remains a need for improving the benefits conferred by dolls and stuffed animals.

### SUMMARY OF THE INVENTION

The present invention addresses the above stated situation by enhancing the effects conferred by medical surrogates or proxies, such as dolls and stuffed animals. Notably, the present invention provides a way of modifying a stuffed animal or doll to make the resultant surrogate more closely approximate an actual surgical patient by incorporating a symbolic organ which can be retrieved and viewed by the patient, then returned to its place.

To this end, the invention contemplates an assembly which can be incorporated into a medical proxy. The assembly includes a symbolic organ, a receptacle for receiving the symbolic organ, and a tether for tethering the symbolic organ to the receptacle.

It is particularly an object of the invention to provide improved elements and arrangements thereof which enables conversion of a medical proxy in the form of a doll or stuffed animal to a medical proxy having an organ which can be retrieved and stowed at will by a person.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a front view of a stuffed animal modified according to the present disclosure; and

FIG. 2 is a front perspective detail view of the center of FIG. 1.

### DETAILED DESCRIPTION

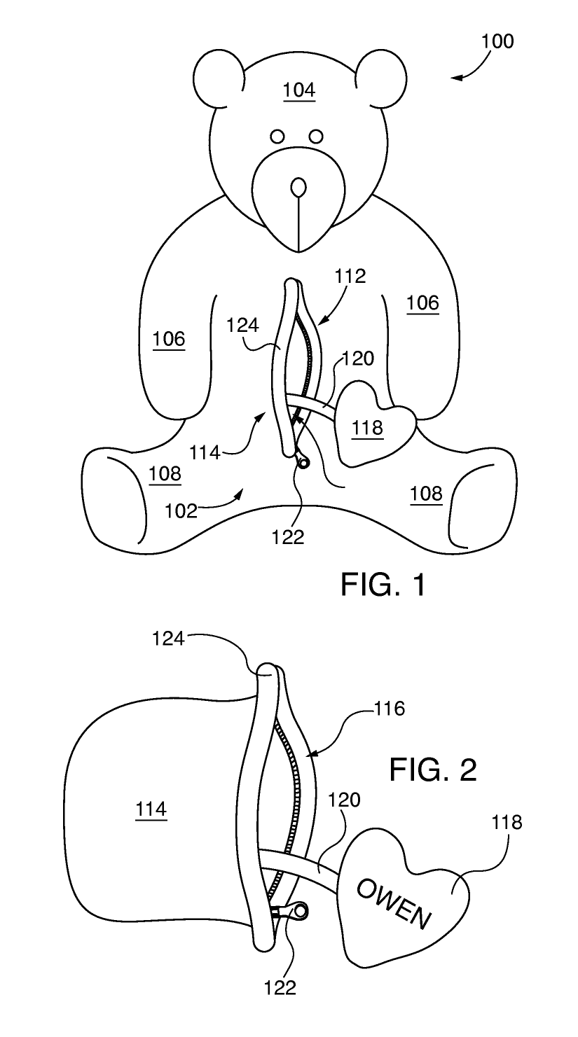

Referring first to FIG. 1, according to at least one aspect of the invention, there is shown an anthropological surrogate 100 for comforting a human patient (not shown) associated with surgery, and to achieve an impression that the anthropological surrogate 100 is specifically associated with the surgery. The anthropological surrogate 100 may be a simulated animate object such as a stuffed animal as depicted in FIG. 1, a doll, or any other simulation of an animate object. The simulated animate object need not be human per se, as simulated animals such as bears and monkeys are know to provide comfort, especially to young patients. The anthropological surrogate 100 comprises a simulated animate object of a type capable of conveying human and animal emotions. Most mammals, such as bears and monkeys, have such characteristics. The anthropological surrogate 100 has a body 102 to which are appended a head 104, arms 106, legs 108, and optionally, other anatomical features such as a tail (not shown). The body 102 includes an interior 110 and an incision 112 in the body 102. The incision 112 exposes the interior 110 and makes accessible a void in the body 102.

Referring also to FIG. 2, a receptacle 114 includes an interior 116, a closure 122 such as a slide contact fastener or zipper which selectively opens and closes the receptacle 114 to finger access. The receptacle 114, which may be a fabric pouch for example, contains a simulated body organ 118 such as a heart, and a tether 120 connecting the simulated body organ 118 to the interior 116 of the receptacle 114. The tether 120, which may be a ribbon, is long enough to enable the simulated body organ 118 to be withdrawn from the receptacle 114. The simulated body organ 118 is preferably but not necessarily a soft fabric envelope, such as flannel or felt, stuffed with a soft filling, such as polyester fibers, so that the simulated body organ 118 is a three dimensional object.

The simulated animate object will become the anthropological surrogate 100 when modified to include the receptacle 114, the simulated body organ 118, and the tether 120. The interior 116 of the receptacle 114 is different from the interior 110 of the anthropological surrogate 100. The interior 110 of the anthropological surrogate 100 is opened only for installation of the receptacle 114 therein, and play no further significant role. The receptacle 114 is contained within the interior 110 of the body 102 of the anthropological surrogate 100, and may be opened by the closure 122 to remove and replace the simulated body organ 118 and the tether 120.

The receptacle 114 may be provided with a closure zone 124 which covers the incision 112 and obstructs access to the interior 110 of the body 102 of the simulated animate object, and the closure 122. The closure selectively closes and opens the closure zone 124 to reveal the interior 116 for removing and replacing the simulated body organ 118. The closure zone 124 may be a fabric flange projecting from the receptacle 114. The fabric flange provides a convenient surface to receive stitching for joining the receptacle 114 to the anthropological surrogate 100. The closure zone 124 may be held to represent scarring incurred by the patient. Alternatively, or in addition, stitching may be provided on the simulated body organ 118 or elsewhere on the anthropological surrogate 100 to represent scarring.

It would be possible to include more than one simulated body organ 118 in the assembly including the receptacle 114.

The simulated body organ 118 may include indicia, such as the patient's name, which may be stitched thereto or otherwise formed.

The invention may be thought of as the anthropological surrogate 100 modified to include the receptacle 114 and the simulated body organ 118, as seen in FIG. 1. Alternatively, the invention may be regarded as an assembly for modifying an anthropological surrogate to render the anthropological surrogate a representation of a human surgical patient. The assembly, shown in FIG. 2, includes the receptacle 114 including the interior 116, the simulated body organ 118, the tether 120, which is fixed at one end to the simulated body organ 118, and at the other end to the interior 116 of the receptacle 114, the closure 122, and optionally, the closure zone 124.

The invention may also be thought of as a method of modifying an anthropological surrogate to render the anthropological surrogate a representation of a human surgical patient. The method may include providing a simulated animate object having a body (e.g., the body 102 of the completed anthropological surrogate 100; cutting an incision (e.g., the incision 112) into the body of the simulated animate object and exposing the interior of the body of the simulated animate object; installing within the body of the simulated animate object a receptacle (e.g., the receptacle 114) containing a simulated body organ (e.g., the simulated body organ 118) and a tether (e.g., the tether 120) connecting the simulated body organ to the interior of the receptacle; and attaching the the receptacle to the interior of the body of the simulated animate object.

The method may include generating a closure zone (e.g., the closure zone 124) which covers the incision and obstructs access to the interior of the body of the simulated animate object. The method may further include providing a closure (e.g., the closure 122) which selectively closes the receptacle and opens the receptacle to finger access. The method may further include providing the anthropological surrogate (e.g., the anthropological surrogate 100), modified to include the receptacle 114 and the tethered simulated body organ 118 installed within the body of the anthropological surrogate to a medical patient associated with a surgical procedure.

The method may include providing the patient's name on the anthropological surrogate 100, such as on the simulated body organ 118.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A method of generating an anthropological surrogate to render the anthropological surrogate a representation of a human surgical patient, comprising:
providing a simulated animate object having a body;
cutting an incision into the body of the simulated animate object and exposing the interior of the body of the simulated animate object;
installing within the body of the simulated animate object a receptacle containing a simulated body organ and a tether connecting the simulated body organ to the interior of the receptacle; and
attaching the the receptacle to the interior of the body of the simulated animate object.

2. The method of claim 1, further comprising generating a closure zone which covers the incision and obstructs access to the interior of the body of the simulated animate object.

3. The method of claim 1, further comprising providing a closure which selectively closes the receptacle and opens the receptacle to finger access.

4. The method of claim 1, further comprising providing the anthropological surrogate, modified to include the receptacle and the tethered simulated body organ installed within the body of the anthropological surrogate to a medical patient associated with a surgical procedure.

5. The method of claim 1, further comprising providing the patient's name on the anthropological surrogate.

6. The method of claim 5, further comprising providing the patient's name on the simulated body organ.

7. An assembly for modifying an anthropological surrogate to render the anthropological surrogate a representation of a human surgical patient, the assembly comprising:
a receptacle including an interior;
a simulated body organ; and
a tether fixed at one end to the simulated body organ, and at the other end to the interior of the receptacle, wherein the tether is long enough to enable the simulated body organ to be withdrawn from the receptacle.

8. An anthropological surrogate for comforting a human patient associated with surgery, and to achieve an impression that the anthropological surrogate is specifically associated with the surgery, the anthropological surrogate comprising:
a simulated animate object having a body including an interior and an incision in the body, the incision exposing the interior of the body; and
a receptacle including an interior, a closure selectively opening and closing the receptacle to finger access, the receptacle containing a simulated body organ and a tether connecting the simulated body organ to the interior of the receptacle, the receptacle contained within the interior of the body of the anthropological surrogate.

9. The anthropological surrogate of claim 8, further comprising a closure zone which covers the incision and obstructs access to the interior of the body of the simulated animate object, and a closure which selectively closes the closure zone.
